(19) United States
(12) Patent Application Publication
(10) Pub. No.: US 2024/0145886 A1
(43) Pub. Date: May 2, 2024

(54) ELECTRIC STORAGE DEVICE

(71) Applicant: Prime Planet Energy & Solutions, Inc., Tokyo (JP)

(72) Inventors: Kaito KARASUNO, Kakogawa-shi (JP); Hiroshi TAKABAYASHI, Koriyama-shi (JP)

(21) Appl. No.: 18/469,554

(22) Filed: Sep. 19, 2023

(30) Foreign Application Priority Data
Oct. 28, 2022 (JP) 2022-173420

(51) Int. Cl. H01M 50/586; H01M 50/184; H01M 50/531; H01M 50/627

(52) U.S. Cl. CPC H01M 50/586; H01M 50/184; H01M 50/531; H01M 50/627

(57) ABSTRACT

Provided is a technique decreasing a risk of damaging inside of an electrode assembly by an electrolytic solution injection. The electric storage device includes an electrode assembly, an electrolytic solution, an outer case, a sealing plate, and a current collector. The electrode assembly includes an electrode tab. The outer case includes an opening. The sealing plate is provided with a liquid injection hole. The current collector is attached to the sealing plate, and is electrically connected to the electrode assembly via the electrode tab. On the sealing plate, the liquid injection hole is provided not to overlap with a portion to which the current collector is attached. Between the liquid injection hole and the electrode assembly, a shielding part is provided to inhibit the electrolytic solution injected through the liquid injection hole from directly coming into contact with the electrode assembly.

### CROSS REFERENCE TO RELATED APPLICATIONS

The present application claims the priority based on Japanese Patent Application No. 2022-173420 filed on Oct. 28, 2022, the entire contents of which are incorporated in the present specification by reference.

### BACKGROUND OF THE DISCLOSURE

### 1. Technical Field

A present disclosure relates to an electric storage device.

### 2. Background

Japanese Patent Application Publication No. 2019-129129 discloses an electric storage apparatus that includes an electrode assembly, an outer case configured to accommodate the electrode assembly, a cover configured to cover the outer case, and an electrode terminal. The cover of the electric storage apparatus described above is provided with a liquid injection hole configured for performing a liquid injection of an electrolytic solution into the outer case. The cover is provided with a cylinder body that is configured to extend from the cover toward the electrode assembly so as to surround an opening of the liquid injection hole on a surface of the cover at an electrode assembly side. Then, the cylinder body described above includes a shielding part configured to couple with the cylinder body and disposed between the liquid injection hole and the electrode assembly. This cited document describes that it is possible by including the shielding part to reduce a flow velocity of the electrolytic solution when the electrolytic solution injected into the outer case collides with the electrode assembly. Then, it describes that it is possible by this to suppress a material of the electrode assembly from being damaged, peeled off, and fallen.

In this cited document, the cover is provided with a current collector configured to electrically connect the electrode assembly and the electrode terminal. The current collector is provided with a penetration hole, and the cylinder body is inserted into the penetration hole. For connecting the electrode assembly and the electrical collector terminal, a tab extending from the electrode assembly is attached to the current collector. At that time, a tip end of the tab is opposed to a side surface of the cylinder body inserted into the penetration hole. An electric storage apparatus of this cited document includes two electrode assemblies, and the cylinder body is sandwiched between the tab extending from the electrode assembly and the tab extending from another electrode assembly.

### SUMMARY

Anyway, regarding the electric storage device having a configuration in which the electrode tab is arranged at the cover side, a laminate surface of the electrode on the electrode assembly might be opposed to the cover. In that case, when the electrolytic solution is injected from the cover side, there is a risk that the injected electrolytic solution directly comes into contact with the laminate surface so as to damage an inside of the electrode assembly. Specifically, when the injected electrolytic solution directly comes into contact with the electrode tabs, it tends by the electrode tab to easily induce entering the electrolytic solution into the electrode assembly. The present inventor is thinking to make decreasing the risk that the liquid injection of the electrolytic solution causes damage on the inside of the electrode assembly.

The herein disclosed electric storage device includes an electrode assembly, an electrolytic solution, an outer case, a sealing plate, and a current collector. The electrode assembly includes an electrode tab. The outer case includes an opening and is configured to accommodate the electrode assembly and the electrolytic solution. The sealing plate is configured to cover the opening. The sealing plate is provided with a liquid injection hole configured to inject the electrolytic solution into the outer case through. The current collector is a member attached to the sealing plate and electrically connected to the electrode assembly via the electrode tab. On the sealing plate, the liquid injection hole is provided not to overlap with a portion to which the current collector is attached. A shielding part is provided between the liquid injection hole and the electrode assembly to inhibit the electrolytic solution injected through the liquid injection hole from directly coming into contact with the electrode assembly.

In the electric storage device having the above described configuration, on the sealing plate, the liquid injection hole is provided not to overlap with an attachment portion of the current collector to which the electrode tab is attached. By this, it is possible to separate the portion, into which the electrolytic solution is injected, from the portion where the impact caused by the liquid injection tends to damage the electrode assembly. By providing the shielding part between the liquid injection hole and the electrode assembly, it is possible to suppress the electrolytic solution injected through the liquid injection hole from directly coming into contact with the electrode assembly. Thus, it is possible to decrease the risk that the liquid injection of the electrolytic solution might cause the damage inside the electrode assembly.

In a preferable aspect, the herein disclosed electric storage device includes an insulating member between the sealing plate and the current collector. The insulating member includes a body and the shielding part. The body is arranged between the sealing plate and the current collector, and the shielding part is in a plate shape extending outwardly from the body. The insulating member having the above described configuration is formed integrally with the body and the shielding part. Thus, in addition to the above described effect, it is possible to implement the effect of omitting use of a different member provided for attaching the shielding part.

It is preferable that the shielding part is inclined toward the electrode assembly. In accordance with such a configuration, it is possible to guide a flow of the electrolytic solution on the shielding part. Thus, it is possible to further suitably implement the inside damage risk decreasing effect for the above described electrode assembly.

It is preferable that a tip end of the shielding part comes into contact with a top end of the electrode assembly opposed to the sealing plate. According to such a configuration, it is possible in addition to the above described effect to implement the effect of suppressing movement of the electrode assembly.

In another preferable aspect of the herein disclosed electric storage device, a width of a tip end of the shielding part is smaller than a width of a base end of the shielding part. In accordance with such a configuration, it is possible to further enhance the inside damage risk decreasing effect for the electrode assembly.

The shielding part may be in an approximately rectangular plate shape. The shielding part at a tip end may include a straight portion and two curved portions respectively disposed at both ends of the straight portion. The configuration described above is suitable for enhancing the above described effect.

The tip end might be in an R shape or a polygon shape more than a quadrilateral shape. The configuration described above is suitable for enhancing the above described effect.

In another preferable aspect of the herein disclosed electric storage device, a slit is provided on a surface at a side of the sealing plate of the shielding part. In accordance with such a configuration, it is possible to further enhance the inside damage risk decreasing effect for the electrode assembly.

### BRIEF DESCRIPTION OF THE DRAWINGS

FIG. 1 is a cross section view of an electric storage device 100.

FIG. 2 is a II-II cross section view of FIG. 1.

FIG. 3 is a perspective view of a first insulating member 91.

FIG. 4 is a cross section view of an electric storage device 200.

### DESCRIPTION OF THE EMBODIMENTS

Below, an embodiment of a herein disclosed electric storage device will be explained. The embodiment explained here is, of course, not intended to particularly restrict a herein disclosed technique. The herein disclosed technique is not restricted to the herein explained embodiment, unless specifically mentioned. Each figure is schematically drawn, and thus might not always reflect the real one. Members/portions contributing in the same effect are suitably provided with the same reference sign, and an overlapping explanation might be omitted. A wording “A to B” representing a numerical value range might mean “equal to or more than A and not more than B” and might semantically cover “more than A and less than B”, unless specifically mentioned.

In the present specification, a term “electric storage device” means a device that induces charging and discharging by making charge carriers move between a pair of electrodes (positive electrode and negative electrode) via an electrolyte. The electric storage device described above semantically covers a secondary battery, such as lithium ion secondary battery, nickel hydrogen battery, and nickel cadmium battery; and a capacitor, such as lithium ion capacitor and electric double layer capacitor. Below, as an example of the above described electric storage device, an embodiment in which the lithium ion secondary battery is set to be a target will be described.

### First Embodiment

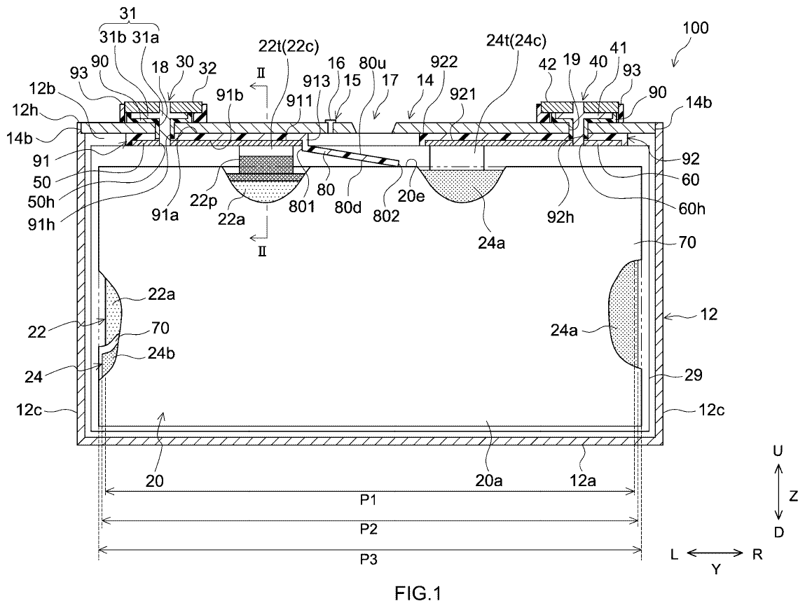

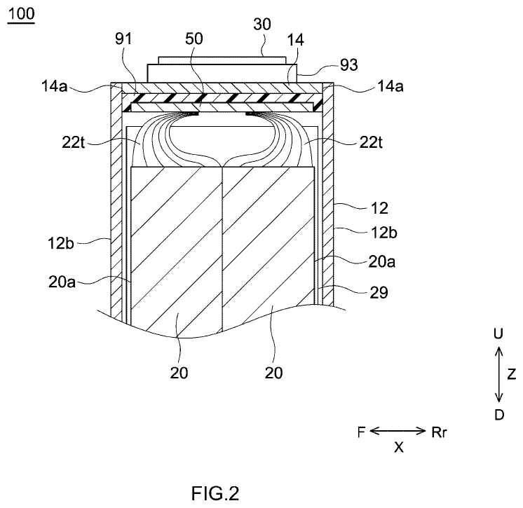

FIG. 1 is a cross section view of an electric storage device 100. FIG. 2 is a II-II cross section view of FIG. 1. FIG. 1 shows a state in which an inside is exposed along a wide width surface 12b of an outer case 12 of the electric storage device 100. FIG. 2 shows a state in which the inside is exposed along a narrow width surface 12c of the outer case 12 of the electric storage device 100. Incidentally, reference signs L, R, U, D, F, and Rr in figures respectively represent left, right, up, down, front, and rear. In figures, a reference sign X represents a short side direction of the electric storage device 100, a reference sign Y represents a long side direction of the electric storage device 100, and a reference sign Z represents a vertical direction (height direction) of the electric storage device 100. However, these are merely directions for convenience of explanation, which never restrict the disposed form of the electric storage device 100.

As shown in FIG. 1 and FIG. 2, the electric storage device 100 includes an outer case 12, a sealing plate 14, an electrode assembly 20, a positive electrode terminal 30, a negative electrode terminal 40, a positive electrode current collector 50, a negative electrode current collector 60, members having an insulating property, and a shielding part 80. The electric storage device 100 herein is a lithium ion secondary battery. As the illustration is omitted, the electric storage device 100 herein further includes an electrolytic solution.

The outer case 12 is, for example, a housing configured to accommodate the electrode assembly 20. The outer case 12 includes, as shown in FIG. 1 and FIG. 2, an opening 12h, a bottom surface 12a, a pair of wide width surfaces 12b, and a pair of narrow width surfaces 12c. In this embodiment, the bottom surface 12a is in an approximately rectangular shape, and is opposed to the opening 12h. The pair of wide width surfaces 12b are configured to extend from a pair of opposed long sides of the bottom surface 12a. The pair of narrow width surfaces 12c are configured to extend from a pair of opposed short sides of the bottom surface 12a. In this embodiment, an area size of the wide width surface 12b is larger than an area size of the narrow width surface 12c. The opening 12h is in an approximately rectangular shape, and is attached to the sealing plate 14. Then, by making the sealing plate 14 be joined to a circumferential edge of the opening 12h, the outer case 12 and the sealing plate 14 are integrated so as to be airtightly sealed.

The sealing plate 14 is, for example, a member in a flat plate shape so as to close the opening 12h. The sealing plate 14 is, for example, enough to be in a shape corresponding to a shape of the opening 12h. In this embodiment, the sealing plate 14 is in an approximately rectangular shape. The sealing plate 14 includes, as shown in FIG. 1 and FIG. 2, a pair of long side parts 14a opposed to each other and a pair of short side parts 14b opposed to each other. In FIG. 1, the pair of short side parts 14b are respectively arranged at a left end part and a right end part. As shown in FIG. 1, the sealing plate 14 is, for example, provided with a liquid injection hole 15 and an exhaust valve 17. The liquid injection hole 15 is for injecting the electrolytic solution into the outer case 12 through after the sealing plate 14 is assembled to the outer case 12. The liquid injection hole 15 is sealed by a sealing member 16. The exhaust valve 17 is a thin-walled part that is configured to be broken, when a pressure inside the outer case 12 after sealing becomes equal to or more than a predetermined value, so as to exhaust the inside gas to the outside.

The electrode assembly 20 is, for example, a power generating element of the electric storage device 100. As shown in FIG. 2, the electric storage device 100 includes two electrode assemblies 20 that are arranged adjacent to each other. These adjacent two electrode assemblies 20 are, as shown in FIG. 1 and FIG. 2, accommodated in the outer case 12 under a state of being covered by an electrode assembly holder 29. As shown in FIG. 1, the electrode assembly 20 includes a positive electrode plate 22 in a rectangular sheet shape, a negative electrode plate 24 in a rectangular sheet shape, and a separator 70 configured to work as a separator. The positive electrode plate 22 and the negative electrode plate 24 have laminate structures in which electrode plates are laminated via the separators 70. Here, regarding the electrode assembly 20, a so-called laminate type electrode assembly is illustrated in which the positive electrode plates 22 and the negative electrode plates 24, each in a predetermined shape, are overlaid while the separators 70 are disposed between them.

The positive electrode plate 22 includes, as shown in FIG. 1, a positive electrode current collecting foil 22c in an approximately rectangular shape, and a positive electrode active material layer 22a formed on the positive electrode current collecting foil 22c. The positive electrode active material layers 22a are respectively formed on both side surfaces of the positive electrode current collecting foil 22c. In this embodiment, a formation area of the positive electrode active material layer 22a is in a rectangular shape. The positive electrode plate 22 includes a positive electrode tab 22t configured to protrude from one side of the formation area of the positive electrode active material layer 22a. The positive electrode tab 22t is a part of the positive electrode current collecting foil 22c, and is an unformed part where the positive electrode active material layer 22a is not formed on the surface. In this embodiment, a positive electrode protective layer 22p is formed at a boundary between the positive electrode active material layer 22a and the positive electrode tab 22t. The positive electrode protective layer 22p herein is formed at an end part of the positive electrode active material layer 22a in a protruding direction of the positive electrode tab 22t, and is disposed adjacent to the positive electrode tab 22t. Incidentally, it is not essential to form the positive electrode protective layer 22p.

As the positive electrode current collecting foil 22c, it is possible, for example, to use an aluminum foil. The positive electrode active material layer 22a is a layer containing a positive electrode active material. The positive electrode active material is, for example, a material like a lithium transition metal composite material for the lithium ion secondary battery, which can release a lithium ion at an electrically charging time and can absorb the lithium ion at an electrically discharging time. As the positive electrode active material, various materials other than the lithium transition metal composite material are generally proposed, which is not particularly restricted. The positive electrode protective layer 22p is, for example, a layer containing an inorganic filler, such as alumina.

The negative electrode plate 24 includes, as shown in FIG. 1, a negative electrode current collecting foil 24c in an approximately rectangular shape and a negative electrode active material layer 24a formed on the negative electrode current collecting foil 24c. The negative electrode active material layers 24a are respectively formed on both side surfaces of the negative electrode current collecting foil 24c. In this embodiment, a formation area of the negative electrode active material layer 24a is in a rectangular shape. The negative electrode plate 24 includes a negative electrode tab 24t configured to protrude from one side of the formation area of the negative electrode active material layer 24a described above. The negative electrode tab 24t is a part of the negative electrode current collecting foil 24c, and is an unformed part where the negative electrode active material layer 24a is not formed on the surface.

As the negative electrode current collecting foil 24c, it is possible, for example, to use a copper foil. The negative electrode active material layer 24a is a layer containing a negative electrode active material. The negative electrode active material is, for example, a material like a natural graphite for the lithium ion secondary battery, which can store the lithium ion at the electrically charging time and can release the lithium ion, stored at the electrically charging time, at the electrically discharging time. As the negative electrode active material, various materials other than the natural graphite are generally proposed, which is not particularly restricted.

The separator 70 is in an approximately rectangular shape on this embodiment, and is formed one size larger than the negative electrode active material layer 24a to implement covering the negative electrode active material layer 24a. As the separator 70, for example, a porous resin sheet is used through which an electrolyte having a necessary heat resistant property can pass. As the separator 70, various materials are proposed, which is not particularly restricted.

As shown in FIG. 1, a width P2 of the negative electrode active material layer 24a in a long side direction of the bottom surface 12a is longer than a width P1 of the positive electrode active material layer 22a in the same direction. A width P3 of the separator 70 in the long side direction of the bottom surface 12a is longer than the width P2 of the negative electrode active material layer 24a. The positive electrode tab 22t and the negative electrode tab 24t have necessary lengths so as to protrude from the separator 70. The positive electrode plate 22, the negative electrode plate 24, and the separator 70 are, as shown in FIG. 1, overlaid so as to make the negative electrode active material layer 24a cover the positive electrode active material layer 22a in a state where the separator 70 is disposed between them and to make the positive electrode tab 22t and the negative electrode tab 24t protrude from the separator 70. In this embodiment, on a rectangular area formed by making the positive electrode plate 22 and the negative electrode plate 24 be overlaid via the separator 70, the positive electrode active material layers 22a are formed on the both surfaces of the positive electrode plate 22 and the negative electrode active material layers 24a are formed on the both surfaces of the negative electrode plate 24. At one of end parts (here, top end 20e of the electrode assembly 20) of the above described rectangular area, plural positive electrode tabs 22t protrude in a state of being superimposed. At the above described one of end parts, plural negative electrode tabs 24t protrude in a state of being superimposed.

Regarding the electrode assembly 20, as shown in FIG. 1 and FIG. 2, a body excluding the positive electrode tab 22t and the negative electrode tab 24t is in a flat rectangular parallelepiped shape having a pair of wide width rectangular surfaces 20a. In this embodiment, end surfaces of each electrode plate and the separator 70 in a laminate direction (direction X in FIG. 2) configure the wide width rectangular surface 20a. Regarding the above described body, 4 side surfaces excluding the pair of wide width rectangular surfaces 20a configure a laminate surface with the positive electrode plate 22, the negative electrode plate 24, and the separator 70.

The positive electrode terminal 30 is, for example, a member electrically connected to the positive electrode plate 22 of the electrode assembly 20. As shown in FIG. 1, the positive electrode terminal 30 is inserted into a terminal taking out hole 18 so as to be exposed on an outer surface of the sealing plate 14. Here, the positive electrode terminal 30 includes a first conductive member 31 and a second conductive member 32. The first conductive member 31 includes a shaft part 31a and a base part 31b. The shaft part 31a is, for example, in a cylindrical shape, is inserted into penetration holes of the terminal taking out hole 18 and the second conductive member 32, and is inserted into a penetration hole 50h of the positive electrode current collector 50. The base part 31b is, for example, in a flat plate shape, and is arranged along an outer surface of the sealing plate 14. Regarding a formation shown in FIG. 1, the second conductive member 32 is, for example, in a flat plate shape, and is arranged along the outer surface of the sealing plate 14. The first conductive member 31 and the second conductive member 32 are mutually connected at an outer surface side of the sealing plate 14. The first conductive member 31 can be, for example, configured with aluminum or aluminum alloy. The second conductive member 32 can be, for example, configured with aluminum, aluminum alloy, copper, copper alloy, or the like.

The negative electrode terminal 40 is, for example, a member electrically connected to the negative electrode plate 24 of the electrode assembly 20. As shown in FIG. 1, the negative electrode terminal 40 is inserted into a terminal taking out hole 19 so as to be exposed on the outer surface of the sealing plate 14. Here, the negative electrode terminal 40 includes a first conductive member 41 and a second conductive member 42. The first conductive member 41 can be, for example, configured with copper or copper alloy. Further, the negative electrode terminal 40 can have a configuration similar to the positive electrode terminal 30. Thus, explanation about the configuration of the negative electrode terminal 40 is omitted, here.

The positive electrode current collector 50 is, for example, a member electrically connected to the electrode assembly 20 via the plural overlaid positive electrode tabs 22t. The positive electrode current collector 50 is, for example, a conductive member in a rectangular flat plate shape. On the formation shown by FIG. 1, the positive electrode current collector 50 is configured to extend along an inner surface of the sealing plate 14. On the formation shown by FIG. 1, the positive electrode current collector 50 is attached to the sealing plate 14, not to overlap with the liquid injection hole 15. The positive electrode current collector 50 includes the penetration hole 50h. Into the penetration hole 50h, the positive electrode terminal 30 is inserted. To the positive electrode current collector 50, plural overlaid positive electrode tabs 22t are joined. The positive electrode current collector 50 can be, for example, configured with aluminum or aluminum alloy.

The negative electrode current collector 60 is, for example, a member electrically connected to the electrode assembly 20 via the plural overlaid negative electrode tabs 24t. The negative electrode current collector 60 is, for example, a conductive member in a rectangular flat plate shape. On the formation shown by FIG. 1, the negative electrode current collector 60 is configured to extend along an inner surface of the sealing plate 14. On the formation shown by FIG. 1, the negative electrode current collector 60 is attached to the sealing plate 14, not to overlap with the liquid injection hole 15. The negative electrode current collector 60 includes a penetration hole 60h. Into the penetration hole 60h, the negative electrode terminal 40 is inserted. To the negative electrode current collector 60, the plural overlaid negative electrode tabs 24t are joined. The negative electrode current collector 60 can be, for example, configured with copper or copper alloy.

On the electric storage device 100, various members each having the insulating property are used. The electric storage device 100 is configured, for example, to include the electrode assembly holder 29, a gasket 90, first insulating members 91, 92, and a second insulating member 93 (see FIG. 1 and FIG. 2). The electrode assembly holder 29 is, for example, a member for inhibiting conduction between the electrode assembly 20 and the outer case 12. Here, the electrode assembly 20 is arranged inside the outer case 12 under a state of being covered with the electrode assembly holder 29. The electrode assembly holder 29 consists, for example, of a resin sheet having an insulating property.

The gasket 90 and the second insulating member 93 are, for example, members respectively configured to inhibit conduction between the positive electrode terminal 30 and the sealing plate 14 and inhibit conduction between the negative electrode terminal 40 and the sealing plate 14. The gasket 90 herein is arranged between the first conductive member 31 at the positive electrode side and the outer surface of the sealing plate 14 and between the first conductive member 41 at the negative electrode side and the outer surface of the sealing plate 14. The gasket 90 is attached between an inner periphery of the terminal taking out hole 18 and an inner periphery of the terminal taking out hole 19. The second insulating member 93 herein is arranged between the second conductive member 32 at the positive electrode side and the outer surface of the sealing plate 14, and between the second conductive member 42 at the negative electrode side and the outer surface of the sealing plate 14.

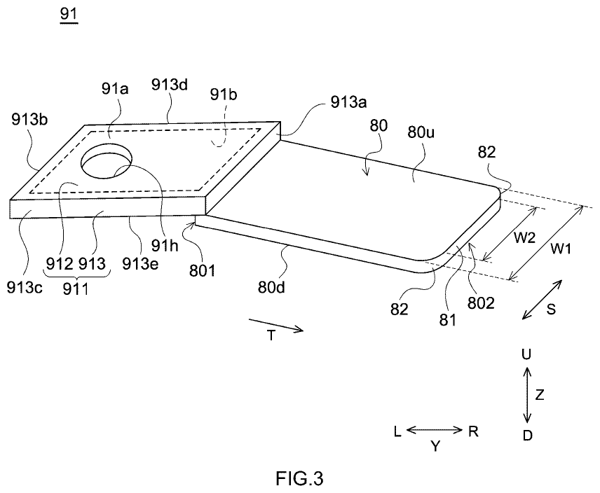

FIG. 3 is a perspective view of the first insulating member 91. FIG. 3 shows a perspective view of the first insulating member 91 viewed from a first surface 91a at the sealing plate 14 side in FIG. 1. The first insulating member 91 is, for example, a member configured to inhibit conduction between the positive electrode current collector 50 and the sealing plate 14. The first insulating member 91 herein is arranged between the positive electrode current collector 50 and the inner surface of the sealing plate 14. As shown in FIG. 1 and FIG. 3, the first insulating member 91 includes a body 911 and a shielding part 80. The body 911 is, for example, a portion arranged between the sealing plate 14 and the positive electrode current collector 50. As shown in FIG. 3, the body 911 includes a flat part 912 and a wall part 913. The flat part 912 is, for example, in a rectangular flat plate shape and is a portion on which the positive electrode current collector 50 is arranged. On the formation shown by FIG. 1, the flat part 912 is attached to the inner surface of the sealing plate 14 under a state where the first surface 91a is disposed at the inner surface side of the sealing plate 14 and a second surface 91b is disposed at the electrode assembly side. Here, the positive electrode current collector 50 is arranged on the second surface 91b. The second surface 91b in FIG. 1 is a surface at a side opposite to the first surface 91a and a surface at a side of the electrode assembly 20 accommodated in the outer case 12. The flat part 912 herein includes the penetration hole 91h. Regarding arrangement of the positive electrode current collector 50 on the flat part 912, for example, the penetration hole 50h of the positive electrode current collector 50 is overlaid with the penetration hole 91h. Into the penetration hole 91h, for example, a part of the gasket 90 is inserted.

The wall part 913 is, for example, a portion configured to surround a circumferential edge of the positive electrode current collector 50 arranged on the flat part 912 (here, second surface 91b). As shown in FIG. 1 and FIG. 3, the wall part 913 is configured to extend from the circumferential edge of the flat part 912 (here, circumferential edge of the second surface 91b). On the formation shown by FIG. 1, the wall part 913 is configured to extend toward the electrode assembly 20. As shown in FIG. 3, the wall part 913 includes a pair of opposed first wall parts 913a, 913b, and a pair of opposed second wall parts 913c, 913d. The first wall parts 913a, 913b are, for example, approximately parallel to the short side parts 14b of the sealing plate 14. The first wall part 913a is, for example, arranged at a center side (liquid injection hole 15 side in FIG. 1) of the sealing plate 14 (see FIG. 1). The first wall part 913b is, for example, arranged at a left side end part of the sealing plate 14 (see FIG. 1). The second wall parts 913c, 913d are, for example, approximately parallel to the long side parts 14a of the sealing plate 14. The second wall part 913c is, for example, arranged at a near side of the sealing plate 14 (not shown in figures). The second wall part 913d is, for example, arranged at a far side of the sealing plate 14 (not shown in figures).

An extending end 913e of the wall part 913 is provided with the shielding part 80. Here, the shielding part 80 is provided on the extending end 913e of the first wall part 913a. In this embodiment, the body 911 of the first insulating member 91 is formed integrally with the shielding part 80. Regarding the first insulating member 91, by providing the shielding part 80 configured to extend from the body 911, it is possible to omit using a different member provided for attaching the shielding part 80. Incidentally, the first insulating member 91 is an example of “insulating member” of the herein disclosed electric storage device.

The shielding part 80 is, for example, a member configured to shield the electrode assembly 20 from the electrolytic solution injected through the liquid injection hole 15. The shielding part 80 is, for example, in an approximately rectangular plate shape. As shown in FIG. 1, the shielding part 80 is provided between the liquid injection hole 15 and the electrode assembly 20. In this embodiment, an upper surface 80u of the shielding part 80 is arranged at the inner surface side of the sealing plate 14. The upper surface 80u herein is a surface configured to receive the electrolytic solution injected from the liquid injection hole 15, and becomes a flow channel of the electrolytic solution. A lower surface 80d is arranged at the top end 20e side of the electrode assembly 20. As described above, the shielding part 80 is formed integrally with the first insulating member 91. In this embodiment, the shielding part 80 is configured to extend outwardly from the extending end 913e of the wall part 913. An extending direction of the shielding part 80 is shown by an arrow T in FIG. 3. In a below described explanation, the direction described above might be referred to as simply “extending direction T”.

On the formation shown by FIG. 3, the shielding part 80 is configured to be inclined with respect to the flat part 912. As shown in FIG. 1, the shielding part 80 is configured to be inclined with respect to the sealing plate 14, and to be inclined toward the electrode assembly 20. By this, it is possible to guide a flow of the electrolytic solution from the shielding part 80 to the electrode assembly 20. Thus, it is possible to adjust a downflow direction of the electrolytic solution, and therefore it is possible to decrease an impact on the electrode assembly 20 which is caused by the electrolytic solution having fallen from the shielding part 80. From the perspective described above, an inclined angle of the shielding part 80 with respect to the top end 20e of the electrode assembly may be set, for example, more than 10 degree and not more than 40 degree. Incidentally, the top end 20e in FIG. 1 is an end part of the electrode assembly 20 at the sealing plate 14 side.

In this embodiment, a tip end 802 of the shielding part 80 comes into contact with the top end 20e of the electrode assembly 20. By this, it is possible to further suitably guide the flow of the electrolytic solution from the shielding part 80 to the electrode assembly 20. Thus, it is possible to further decrease the impact on the electrode assembly 20 which is caused by the electrolytic solution having fallen from the shielding part 80. It is possible to suppress the electrode assembly 20 from moving in a height direction of the electric storage device 100. Incidentally, the tip end 802 of the shielding part 80 in FIG. 1 and FIG. 3 is an end part in the extending direction T, which is an end part at a side opposite to the base end 801.

In this embodiment, a width W2 of the tip end 802 of the shielding part 80 is set to be smaller than a width W1 of the base end 801 (see FIG. 3). By this, it is possible to disperse directions in which the electrolytic solution falls at the tip end 802. Thus, it is possible to decrease the impact caused by the electrolytic solution having fallen from the shielding part 80. Incidentally, in the present specification, a wording “width” related to the shielding part 80 means a length in a width direction S of the shielding part 80 orthogonal to the direction T.

On the formation shown by FIG. 3, the shielding part 80 at the tip end 802 includes a straight portion 81 and two curved portions 82. These two curved portions 82 are respectively provided on both ends of the straight portion 81. As described above, in this embodiment, the shielding part 80 is in an approximately rectangular plate shape, and thus two corners of the tip end 802 are cut out to be curved. By this, the tip end 802 is provided with the straight portion 81 whose width W2 is shorter than the width W1 of the base end 801, and thus each of the both ends of the straight portion 81 is provided with the curved portion 82. Regarding the shielding part 80, the electrolytic solution injected from the liquid injection hole 15 flows, for example, toward the tip end 802 on the upper surface 80u, and then falls from the straight portion 81 and these two curved portions 82 toward the electrode assembly 20. As described above, on the shielding part 80, it is possible at the tip end to disperse directions in which the electrolytic solution falls. Therefore, it is possible to decrease the impact on the electrode assembly 20 caused by the electrolytic solution having fallen.

The first insulating member 92 is, for example, a member configured to inhibit conduction between the negative electrode current collector 60 and the sealing plate 14. The first insulating member 92 herein is arranged between the negative electrode current collector 60 and the inner surface of the sealing plate 14. As shown in FIG. 1, the first insulating member 92 includes a penetration hole 92h, a flat part 921, and a wall part 922. The first insulating member 92 herein does not include the shielding part 80. About the other configurations, it includes the same configuration as the first insulating member 91 at the positive electrode side. Thus, explanation about the configuration of the first insulating member 92 herein is omitted.

Materials for configuring the electrode assembly holder 29, the gasket 90, the first insulating members 91, 92, and the second insulating member 93 are not particularly restricted. As the configuration material described above, it is possible, for example, to use a synthetic resin material, which is a polyolefin resin, such as polypropylene (PP) and polyethylene (PE); a fluorine resin, such as perfluoroalkoxy alkane and polytetrafluoroethylene (PTFE); or the like. Incidentally, in this embodiment, the material for configuring the shielding part 80 is the same as the configuration material of the first insulating member 91.

As described above, the electric storage device 100 includes the electrode assembly 20, the electrolytic solution, the outer case 12, the sealing plate 14, and the positive electrode current collector 50. The electrode assembly 20 includes the positive electrode tab 22t. The outer case 12 has the opening 12h, and is configured to accommodate the electrode assembly 20 and the electrolytic solution. The sealing plate 14 is a member configured to cover the opening 12h, and is provided with the liquid injection hole 15 configured to inject the electrolytic solution into the outer case 12 through. The positive electrode current collector 50 is attached to the sealing plate 14, and is electrically connected to the electrode assembly 20 via the positive electrode tab 22t. On the sealing plate 14, the liquid injection hole 15 is provided not to overlap with a portion on which the positive electrode current collector 50 is attached. Between the liquid injection hole 15 and the electrode assembly 20, the shielding part 80 is provided to inhibit the electrolytic solution injected through the liquid injection hole 15 from directly coming into contact with the electrode assembly 20.

Regarding the electric storage device 100, on the sealing plate 14, the liquid injection hole 15 is provided not to overlap with an attached portion of the positive electrode current collector 50 where the positive electrode tab 22t is attached. By this, when the electrolytic solution is injected, for example, it is possible to suppress the electrolytic solution from being trickled down the positive electrode tab 22t and thus from be injected into the electrode assembly 20. Therefore, it is possible to suppress the liquid injection into a portion which particularly tends to cause damage on the electrode assembly 20 in response to the impact caused by the injected electrolytic solution. By providing the shielding part 80 between the liquid injection hole 15 and the electrode assembly 20, it is possible to suppress the electrolytic solution injected through the liquid injection hole 15 from directly coming into contact with the electrode assembly 20. By this, it is possible to decrease a risk of damage on the electrode assembly 20 caused by the impact at the time of liquid injection of the electrolytic solution.

Although the electric storage device 100 can be used for various purposes, for example, it can be suitably utilized as a power source for motor (power supply for driving) mounted on various vehicles, such as passenger car and truck. Kinds of the vehicle is not particularly restricted, but it is possible to use it, for example, on a plug-in hybrid electric vehicle (PHEV), a hybrid electric vehicle (HEV), a battery electric vehicle (BEV), or the like.

Above, the embodiment for the herein disclosed technique has been explained, but it is not intended that the herein disclosed technique is restricted to the above described embodiment. The herein disclosed technique can be implemented on another embodiment. The technique recited in the appended claims includes variously deformed or changed versions of the embodiments that have been illustrated above. For example, one part of the above described embodiment can be replaced with another deformed aspect, and furthermore another deformed aspect can be added to the above described embodiment. Unless a technical feature is explained to be essential, this technical feature can be appropriately deleted.

### Second Embodiment

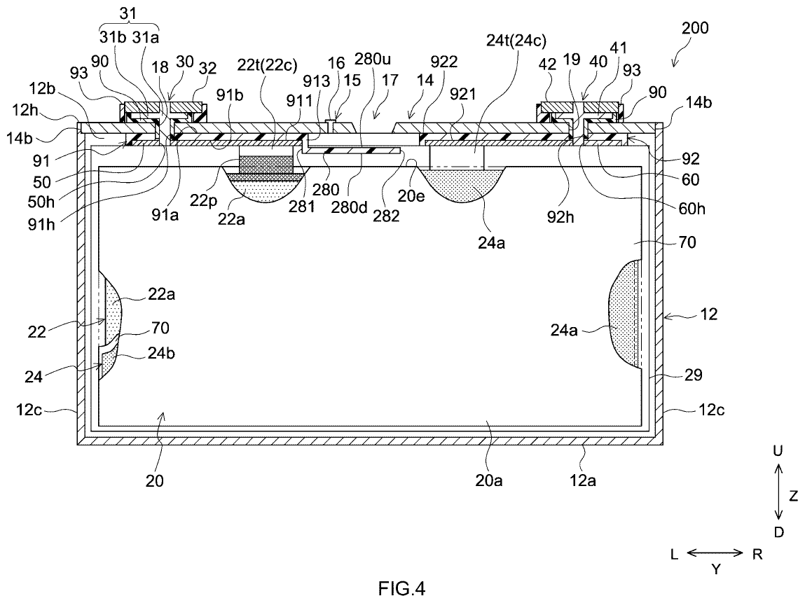

For example, regarding the first embodiment described above, the shielding part 80 having extended is inclined and extending from the first insulating member 91 toward the electrode assembly 20. However, the herein disclosed technique is not restricted to this example. FIG. 4 is a cross section view of an electric storage device 200. As shown in FIG. 4, the electric storage device 200 includes a shielding part 280. The electric storage device 200 includes the first insulating member 91 between the sealing plate 14 and the positive electrode current collector 50. In this embodiment, the shielding part 280 is configured to extend from the body 911 of the first insulating member 91. A base end 281 of the shielding part 280 is, for example, provided at the extending end 913e (for example, extending end 913e of the first wall part 913a: see FIG. 3) of the wall part 913 of the first insulating member 91. On a formation shown in FIG. 4, the shielding part 280 is approximately parallel to the sealing plate 14. An inclined angle of the shielding part 280 with respect to the top end 20e of the electrode assembly may be, for example, set to be −10 degree to +10 degree (for example, −5 degree to +5 degree). Thus, in this embodiment, a tip end 282 of the shielding part 280 does not come into contact with the top end 20e of the electrode assembly 20. Incidentally, in FIG. 4, a reference sign “280u” represents an upper surface of the shielding part 280. A reference sign “280d” represents a lower surface of the shielding part 280.

### Another Embodiment

In the first embodiment and the second embodiment, the shielding part 80 or the shielding part 280 is integrally formed with the first insulating member 91. However, the herein disclosed technique is not restricted to this example. The shielding part 80 and the shielding part 280 might be a member separated from the first insulating member 91. In the first embodiment and the second embodiment, the shielding part 80 or the shielding part 280 is provided on the first insulating member 91 at the positive electrode side. However, the herein disclosed technique is not restricted to this example. The shielding part 80 and the shielding part 280 might be provided on the first insulating member 92 at the negative electrode side.

The shapes of the tip ends 802, 282 of the shielding parts 80, 280 might not be the shapes described in the above described embodiment. The shapes of the tip ends 802, 282 might be, for example, R shapes. The shapes of the tip ends 802, 282 might be polygon shapes more than quadrilateral shapes. By making the shapes of the tip ends 802, 282 be the above described shapes, it is possible at the tip ends 802, 282 to further enhance the effect of dispersing the directions in which the electrolytic solution falls.

Alternatively, surfaces (here, upper surface 80u, 280u) of the shielding parts 80, 280 at the sealing plate 14 side might be provided with slits. By providing the slits on the shielding parts 80, 280, it is possible to further suitably guide the flow of the electrolytic solution. From the perspective described above, the slits might be provided, for example, along the direction T in which the shielding parts 80, 280 extend.

While described above, as a particular aspect for the herein disclosed technique, it is possible to recite about below described items.

Item 1: An electric storage device, comprising:
an electrode assembly that comprises an electrode tab;
an electrolytic solution;
an outer case that has an opening, and is configured to accommodate the electrode assembly and the electrolytic solution;
a sealing plate that is configured to cover the opening and is provided with a liquid injection hole configured to inject the electrolytic solution into the outer case through; and
a current collector that is attached to the sealing plate and is electrically connected to the electrode assembly via the electrode tab, wherein
on the sealing plate, the liquid injection hole is provided not to overlap with a portion to which the current collector is attached, and
a shielding part is provided between the liquid injection hole and the electrode assembly to inhibit the electrolytic solution injected through the liquid injection hole from directly coming into contact with the electrode assembly.

Item 2: The electric storage device recited in item 1, further comprising an insulating member between the sealing plate and the current collector, wherein
the insulating member comprises:
   a body that is arranged between the sealing plate and the current collector; and
   the shielding part that is in a plate shape extending outwardly from the body.

Item 3: The electric storage device recited in item 1 or 2, wherein
the shielding part is inclined toward the electrode assembly.

Item 4: The electric storage device recited in any one of items 1 to 3, wherein
a tip end of the shielding part comes into contact with a top end of the electrode assembly opposed to the sealing plate.

Item 5: The electric storage device recited in any one of items 1 to 4, wherein
a width of a tip end of the shielding part is shorter than a width of a base end of the shielding part.

Item 6: The electric storage device recited in any one of items 1 to 5, wherein
the shielding part is in an approximately rectangular plate shape, and
the shielding part comprises a straight portion disposed at a tip end and two curved portions respectively disposed at both ends of the straight portion.

Item 7: The electric storage device recited in any one of items 1 to 6, wherein
the tip end is in a R shape or a polygon shape more than a quadrilateral shape.

Item 8: The electric storage device recited in any one of items 1 to 7, wherein
a slit is provided on a surface at a side of the sealing plate of the shielding part.

What is claimed is:

1. An electric storage device, comprising:
an electrode assembly that comprises an electrode tab;
an electrolytic solution;
an outer case that has an opening, and is configured to accommodate the electrode assembly and the electrolytic solution;
a sealing plate that is configured to cover the opening and is provided with a liquid injection hole configured to inject the electrolytic solution into the outer case through; and
a current collector that is attached to the sealing plate and is electrically connected to the electrode assembly via the electrode tab,
wherein
on the sealing plate, the liquid injection hole is provided not to overlap with a portion to which the current collector is attached, and
a shielding part is provided between the liquid injection hole and the electrode assembly to inhibit the electrolytic solution injected through the liquid injection hole from directly coming into contact with the electrode assembly.

2. The electric storage device according to claim 1, further comprising an insulating member between the sealing plate and the current collector,
wherein
the insulating member comprises:
a body that is arranged between the sealing plate and the current collector; and
the shielding part that is in a plate shape extending outwardly from the body.

3. The electric storage device according to claim 2, wherein
the shielding part is inclined toward the electrode assembly.

4. The electric storage device according to claim 3, wherein
a tip end of the shielding part comes into contact with a top end of the electrode assembly opposed to the sealing plate.

5. The electric storage device according to claim 2, wherein
a width of a tip end of the shielding part is smaller than a width of a base end of the shielding part.

6. The electric storage device according to claim 5, wherein
the shielding part is in an approximately rectangular plate shape, and
the shielding part comprises a straight portion disposed at a tip end and two curved portions respectively disposed at both ends of the straight portion.

7. The electric storage device according to claim 5, wherein
the tip end is in a R shape or a polygon shape more than a quadrilateral shape.

8. The electric storage device according to claim 1, wherein
a slit is provided on a surface at a side of the sealing plate of the shielding part.
